(19) United States
(12) Patent Application Publication
(10) Pub. No.: US 2002/0157616 A1
(43) Pub. Date: Oct. 31, 2002

(54) Control means for animal feeder system

(76) Inventors: Danny Adams, Bowdon, GA (US); Perry D. Sullivan, Bowdon, GA (US)

Correspondence Address: Herbert M. Hanegan, Smith, Gambrell & Russell, LLP, Suite 3100, Promenade II, 1230 Peachtree Street, N.W., Atlanta, GA, 30309-3592, US

(21) Appl. No.: 10/060,707

(22) Filed: Jan. 30, 2002

Related U.S. Application Data
(60) Provisional application No. 60/265,520, filed on Jan. 31, 2001.

(51) Int. Cl. A01K 1/00; A01K 5/00; A01K 39/00

(52) U.S. Cl. 119/57.92

(57) ABSTRACT

A feed intake control apparatus for a livestock feeding system which includes a hopper between a bulk feed storage and the livestock feeding station(s), said apparatus comprising a means for controlling the pump which supplies feed to the hopper such that the pump does not run for an extended period if feed is not supplied to the pump.

### CROSS-REFERENCE TO RELATED APPLICATIONS

The present application claims priority to provisional application Serial No. 60/265,520, filed Jan. 31, 2001, which is relied on and incorporated herein by reference.

### BACKGROUND OF THE INVENTION

This invention relates to animal or poultry feeding systems in which a pulverant, fluent feed is conveyed to a series of feeding stations where it is dispensed for chickens (or other animals or birds) to eat, and, more particularly, to a controller for a feed intake system to which the feedstock is delivered and from which it is conveyed.

Poultry feeding systems are well-known in the art. See, for example, U.S. Pat. Nos. 4,850,370; 4,460,230; 4,003;339; 3,971,340; 3,598,087; 3,415,228; and 3,230,933. As shown in these representative patents, feedstock from a bulk feed tank or the like is delivered to an intake cup or hopper. From the hopper, the feed is delivered to a conveying means which services a number of feeding stations. In large poultry houses, one of these conveying means may have a length of up to 400 feet and there may be 200-300 or so of the feeding stations. The feed is conveyed, usually by means of an auger in a feed conveyor tube extending through each of the feed stations. The auger may either be rotary driven or axially propelled within the tube to convey the feed from the intake hopper and from feeder to feeder. Feed is deposited from the conveying means into feed pans of the feeders located at each station for subsequent consumption by the birds.

It is a problem with present feeding systems that they can become overloaded, overflow, and/or jammed up with feed. This situation is likely to occur, for example, when the feeders are full and the feedstock pump continues to run. Then a substantial amount of feed is retained in the conveyor loop. At the same time, additional feed is being dispensed from the hopper into the conveyor. When that happens, the pressures created compact the feed in the conveyor loop until all void spaces are filled or packed. The resultant pressures eventually cause the auger to jam and stop moving. For example, in certain of the prior art feeding systems (such as shown in U.S. Pat. No. 4,850,307), it is a feature of these systems that voids are intentionally formed between the flights of the auger within the conveyor tube through the use of baffles within the intake hopper so as to restrict the flow of feed to the auger. However, it has been found that if no feed is being dispensed to the feed stations and as the conveyor is run continuously, these voids tend to become overfilled as more feed is delivered to the auger. The feed at the inlet to the conveying means is also compacted, as is the feed above it. In this latter regard, even if the feed at the inlet to the conveying means is broken up, the compacted feed above it may create a solid bridge preventing any feed from reaching the conveying means from the hopper.

If the further delivery of feed ultimately jams the auger, the conveyor feed tube must be disassembled, the compacted feed cleaned out, and everything then reassembled. The feed intake to the conveying means must also be cleaned out to break up deposits of compacted feed. This is not only a time consuming and expensive process, but it means the poultry is either not fed, or must be fed by hand or in some other manner during the down time.

If the feedstock pump continues to run after the hopper is full, the hopper will overflow until the pump is turned off, thus wasting feed and necessitating downtime and clean up of the overflowed feed.

Likewise if there is an interruption of feed to the hopper, the feedstock pump will continue to run since the hopper has upper and lower feed level switches to control the pump. The pump will continue to operate until the hopper is filled to the upper limit switch with feed.

### SUMMARY OF THE INVENTION

Among the several objects of the present invention is the provision of a feed intake control means for use in a poultry feeder system.

A further object is the provision of such an intake means for delivering feed to a hopper or the like by which the feed is conveyed thru a pump having a controller which allows the pump to be activated only for a limited amount of time and then deactivated before the cycle is repeated.

An additional object is the provision of a means for delivering feed including mechanisms for preventing the pump from running when no feed is available to supply to the hopper.

It is also an object of the present invention to provide a mechanism which regulates the amount of time the feed pump is activated to reduce or eliminate the possibility of the pump running without feed being supplied to the pump.

A further object is the provision of such a control means which is usable with existing feed conveyor systems.

In accordance with the invention, generally stated, a feed intake control means is used in a poultry feeding system for controlling the transferring of feed to a feed hopper. In known feed systems, the feed from the hopper flows to a conveyor by which the feed is delivered to stations spaced along the conveyor. The intake means is a housing with an inlet and an outlet. The inlet is connected to the feed hopper for feed to flow from the hopper into the housing. A feed conveyor is connected to the housing outlet. Feed flows through the housing and onto the conveyor through the outlet. A feed transport auger is positioned in the conveyor. The auger is normally movable through a tube which scrapes excess feed off the auger and helps regulate flow of feed into the conveyor. An agitator may be positioned in the housing and as it moves and agitates the feed the auger moves the feed through the conveyor. The agitator rotates in the housing to produce a stirring action which breaks up lumps in the feed and helps the feed to flow.

### BRIEF DESCRIPTION OF THE DRAWINGS

FIG. 1 is a schematic representation of the control means for the poultry feed delivery system of the present invention.

### DESCRIPTION OF PREFERRED EMBODIMENTS

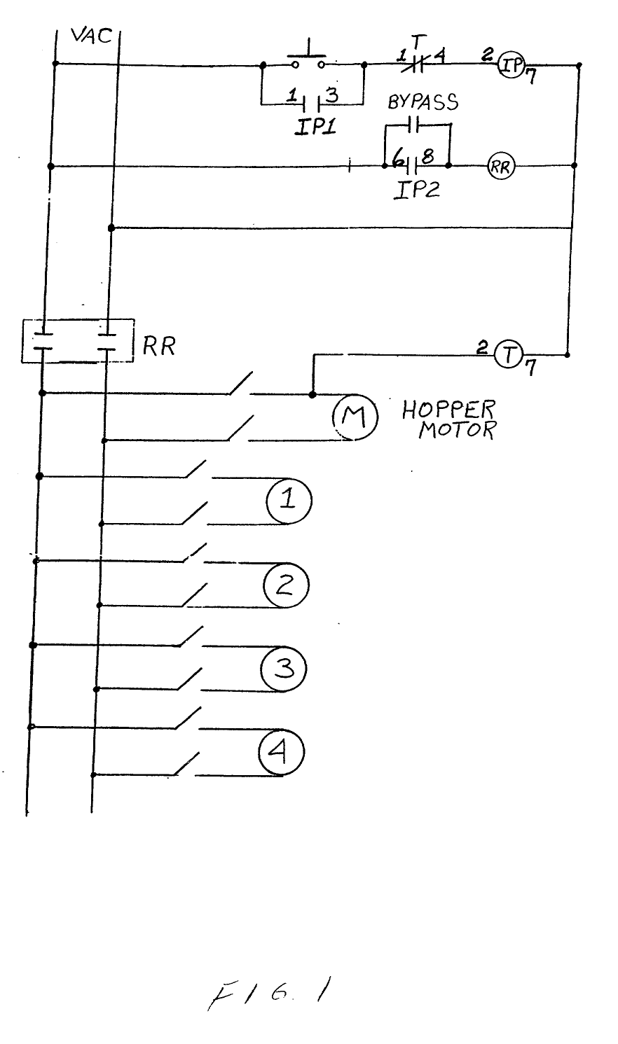

Referring to the drawing, a poultry feeding system is indicated generally in FIG. 1. The system includes a hopper into which feed is received from a bulk feed tank or the like. A hopper motor delivers feed from the bulk feed tank to the hopper. From the hopper the feed gravitates into an intake. From the intake the feed enters a conveyor. The latter can include a conveyor tube in which an auger is located. The auger may be a centerless auger having the appearance of a stretched out coil spring and is driven by a drive mechanism to cause the feed to be transferred by the conveyor to one or more feed stations. The auger may be rotatably or linearly driven by the drive mechanism. The auger may be linearly propelled through the tube by means of a drive gear having gear teeth in mesh with the flight of the auger. Such a drive is described in U.S. Pat. No. 4,460,230. Alternatively, the auger may be rotary driven within the conveyor tube such that the auger acts like a screw to convey the feed through the conveyor tube. Other well-known feed conveyors (e.g., a chain conveyor) may be used. When the auger is linearly propelled, the conveyor may be an endless closed track system in which the conveyor is arranged in a closed loop configuration around the poultry house. Additional drive mechanisms and additional intake feed intakes may be located along the loop to facilitate movement of feed to the various feeders.

In delivering feed to the feeders one problem which may be encountered is feed compaction. Compaction is usually caused by an over abundance of feed being conveyed through the system. If, for example, feed currently in the conveyor is not deposited at a station because the feed already there has not been consumed, excess feed in the conveyor will be circulated back to the feed intake. At the same time, additional feed flows from the hopper into the intake for entry onto the conveyor. Since the flow of feed through the intake is normally by gravity, the feed will exert a substantial amount of hydrostatic pressure so as to pack even more feed onto the feed conveyor. And, since the excess feed in the conveyor is being constantly recirculated throughout the feed loop, rather than deposited at the stations, it often becomes more and more compacted until jamming occurs. If the conveying system gets jammed, it must be disassembled by removing the auger from the conveyor tube, the compacted feed cleaned out, and the system then reassembled. This creates a time consuming and expensive delay especially considering the number of birds fed by the system, and the amount of wasted feed which is created by the jam.

A problem also exists when there is an interruption of feed to the hopper, the feedstock pump will continue to run since the hopper has upper and lower feed level switches to control the pump. The pump will continue to operate until the hopper is filled to the upper limit switch with feed.

Such conditions could be caused by the grower running out of feed, an obstruction of feed between the outside bulk feed and the pump, or where the feed downspout accidentally separates from the inlet pump pipe and feed is being dumped onto the floor of the poultry house rather than into the hopper.

A bulk feed tank is normally located proximate a poultry house in which the feeding system is installed. Typically, such bulk feed tanks (or other storage silos or bins) are used in conjunction with feeding systems to store large quantities of feed and to supply the hopper as previously described. The bulk feed tank normally has a raised tank body with a downwardly converging outlet section. At the bottom end of the outlet section, an outlet boot is provided for directing feed from within the tank to the hopper, normally by a conveyor.

The present invention comprises a feed intake control apparatus for a livestock feeding system, said apparatus having a means for controlling the pump supplying feed to a hopper such that the pump is deactivated if feed is not supplied to the pump. In prior art systems the pump is controlled by limit switches within the hopper whereby the pump is activated when the feed level in the hopper reaches or falls below the lower limit switch and the pump will continue to operate until the feed level in the hopper reaches or exceeds the upper limit switch. Therefore if there is an interruption of feed supply to the pump, the pump will continue to operate for an indefinite period of time because no feed would be reaching the hopper and the feed level in the hopper could not reach the upper limit switch. Advantageously the feed intake control means comprises a timer which allows activation of a feed pump supplying the hopper only for a time sufficient to fill the hopper with feed. Preferably said timer allows activation of said pump for a maximum of about 6 minutes per cycle. Advantageously the timer allows a maximum of about 6 minutes activation, has a manual override to allow manual operation of the pump, and includes adjustment means to adjust the activation and deactivation timing of the pump.

The advantages of the present invention are:

1. It will conserve electricity by shutting down a number (usually five) of electric motors that otherwise would run uselessly when feed is not available to the pump. This can occur when the bulk feed tank is empty, the supply line between the tank and pump is broken or clogged, or the like;

2. It will save the grower money in equipment cost. An auger can cut into the plastic feed conveyor tube if the conveyor is allowed to run empty, thereby necessitating replacement of the fill system and feeder system in the poultry house;

3. It will relieve the grower from replacing motors that have run for lengthy times without a supply of feed and will extend the life of electrical motors in a poultry house;

4. It will prevent large amounts of feed from overflowing into the house if a bulk feed supply pipe falls from the ceiling or becomes separated because feed coming into the house cannot be controlled by hopper switches, resulting in excessive amounts of feed being dumped on the ground inside the house; and

5. The feed intake control apparatus can be connected to the poultry house alarm system whereby the grower will be alerted if a problem with feed delivery arises. The grower can then act in a timely manner so that the chickens are not out of feed for an extended period of time, therefore birds performance will not suffer.

What has been described is an improved feed control means for use in a poultry feeder system by which feed is delivered to a hopper and then to a feed conveyor by which the feed is conveyed to a plurality of feeding sites. The present invention includes a means for controlling the pump to the hopper such that the pump is deactivated if feed is not supplied to the pump. The means for controlling the pump can be any means which deactivates the pump after a specified amount of pump activation time has elapsed. Advantageously the control means is a timer means which only becomes operational after the pump has been activated for a set time and which, when it becomes operational, deactivates the pump to prevent damage to the pump, waste of feed, etc.

In view of the foregoing, it will be seen that the several objects of the invention are achieved and other advantageous results are obtained.

As various changes could be made in the above constructions without departing from the scope of the invention, it is intended that all matter contained in the above description or shown in the accompanying drawings shall be interpreted as illustrative and not in a limiting sense.

What is claimed is:

1. A feed intake control apparatus for a livestock feeding system which includes a hopper, the hopper functioning as a holding vessel for feed between a bulk feed storage and a means for providing feed to at least one livestock feeding station, said apparatus comprising a means for controlling a pump which supplies feed to the hopper such that the pump does not run for an extended period of time if feed is not supplied to the pump.

2. The feed intake control apparatus of claim 1 wherein said control means comprises a monitor which controls the activation and deactivation of the feed pump and allows activation of said pump only for a time normally sufficient to fill the hopper with feed.

3. The feed intake control apparatus of claim 2 wherein said monitor allows activation of said pump for a maximum of about 6 minutes.

4. The feed intake control apparatus of claim 3 wherein said monitor deactivates said pump after it has run for a period of about 6 minutes.

5. The feed intake control apparatus of claim 4 having a manual override to allow manual operation of the pump.

6. The feed intake control apparatus of claim 2 including adjustment means to adjust the activation and deactivation time period of the pump.

7. The feed intake control apparatus of claim 4 including an alarm which is activated when said monitor deactivates said pump.
